(19) United States
(12) Patent Application Publication
(10) Pub. No.: US 2020/0016936 A1
(43) Pub. Date: Jan. 16, 2020

(54) PNEUMATIC TIRE

(71) Applicant: Toyo Tire Corporation, Itami-shi (JP)

(72) Inventor: Taiichi Nishio, Itami-shi (JP)

(73) Assignee: Toyo Tire Corporation, Itami-shi (JP)

(21) Appl. No.: 16/506,060

(22) Filed: Jul. 9, 2019

(30) Foreign Application Priority Data
Jul. 10, 2018 (JP) 2018-130636

(51) Int. Cl. B60C 11/12; B60C 11/03

(52) U.S. Cl. CPC B60C 11/124; B60C 11/0306; B60C 2011/1254; B60C 11/1281; B60C 11/1259

(57) ABSTRACT

A pneumatic tire is provided in which main sipes 20 are formed on land sections of a tread and at least one of ends in an extending direction of each main sipe is a blocked end 21 that is blocked in the land section, auxiliary sipes 23 separated from the main sipe are formed on both sides of the blocked end, the blocked end overlaps with the auxiliary sipes on both sides thereof in a direction orthogonal to the extending direction of the main sipe, a distance between a center in an extending direction of the auxiliary sipe and the blocked end is 10% or more to 20% or less of a depth of the main sipe, the extending direction of the auxiliary sipes is inclined with respect to the extending direction of the main sipe, and the auxiliary sipes are gradually shortened as coming toward a depth direction.

### CROSS-REFERENCE TO RELATED APPLICATION

The present application claims priority from Japanese patent application No. 2018-130636 on the basis of Japanese patent application No. 2018-130636 (filing date: Jul. 10, 2018). The entire contents of Japanese patent application No. 2018-130636 are hereby incorporated into the present application by reference of Japanese patent application No. 2018-130636.

### TECHNICAL FIELD

The present invention relates to a pneumatic tire.

### BACKGROUND ART

In order to improve braking and driving performance and for other purposes, sipes are formed on land sections of a tread in a pneumatic tire in related art. However, stress is concentrated on end parts in an extending direction of sipes when end parts in the extending direction of the sipes are blocked in the land section, therefore, cracks tend to occur from the end parts as starting points.

In response to the above, it has been proposed that branch sipes in which the sipe branches off into two or more in plan view are formed at end parts in the extending direction of the sipe as described in Patent Literature 1. As the branch sipes disperse the stress applied to end parts in the extending direction of the sipes, they are effective for preventing occurrence of cracks.

Patent Literature 1: JP-A-2006-341688

### SUMMARY OF INVENTION

However, as a result that the branch sipes are formed at the end parts in the extending direction of the sipes, there is a problem that rigidity of the land sections in the tread is reduced. The reduction in rigidity of the land sections in the tread causes deterioration such as wear in the land sections.

In view of the above, an object of the present invention is to provide a pneumatic tire in which cracks starting from end parts in the extending directions of sipes hardly occur and rigidity of the land section in the tread is not reduced too much.

In a pneumatic tire according to the embodiment in which main sipes are formed on land sections of a tread and at least one of ends in an extending direction of each main sipe is a blocked end that is blocked in the land section, auxiliary sipes separated from the main sipe are formed on both sides of the blocked end, the blocked end overlaps with the auxiliary sipes on both sides thereof in a direction orthogonal to the extending direction of the main sipe, a distance between a center in an extending direction of the auxiliary sipe and the blocked end is 10% or more to 20% or less of a depth of the main sipe, the extending direction of the auxiliary sipes is inclined with respect to the extending direction of the main sipe, and the auxiliary sipes are gradually shortened as coming toward a depth direction.

In the pneumatic tire according to the embodiment, stress is hardly concentrated on the blocked ends of the main sipes due to the existence of the auxiliary sipes, therefore, cracks starting from the blocked ends of the main sipes hardly occur. Furthermore, the auxiliary sipes are separated from the main sipe 20 and are gradually shortened as coming toward the depth direction, therefore, rigidity of the land sections in the tread is not reduced too much.

### BRIEF DESCRIPTION OF THE DRAWINGS

FIG. 1 shows a tread pattern according to an embodiment.

FIG. 2 is a plan view showing a block according to the embodiment.

FIG. 3 is a cross-sectional view (cross-sectional view in A-A position of FIG. 2) of an auxiliary sipe in a depth direction and an extending direction according to the embodiment;

FIG. 4 is a cross-sectional view (cross-sectional view in B-B position of FIG. 2) of a main sipe and auxiliary sipes in a depth direction according to the embodiment.

FIG. 5 is a cross-sectional view (cross-sectional view in a position corresponding to A-A of FIG. 2) of an auxiliary sipe in a depth direction and an extending direction according to a modification example.

FIG. 6 is a cross-sectional view (cross-sectional view in a position corresponding to B-B of FIG. 2) of a main sipe and auxiliary sipes in a depth direction according to a modification example.

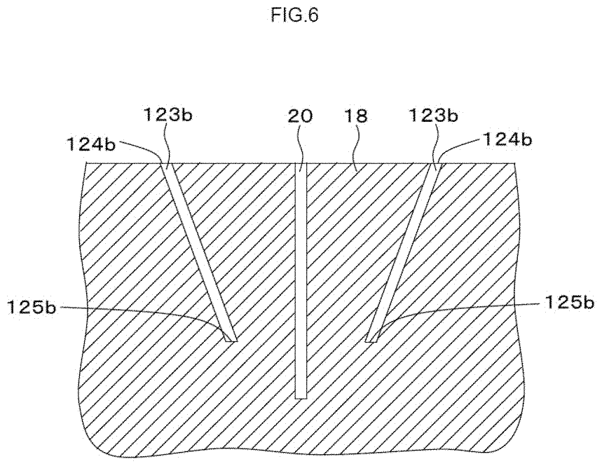

### MODE FOR CARRYING OUT THE INVENTION

A structure of a pneumatic tire according to an embodiment will be explained with reference to the drawings. A brand-new unworn pneumatic tire will be explained below unless otherwise particularly mentioned. Also in the following explanation, plan view means that the tread is seen from an outer side in a tire radial direction.

A heavy load tire fitted to a truck or a bus is assumed to be used as an example of the pneumatic tire according to the embodiment. A studless tire fitted at the time of traveling on an icy road is also assumed to be used as an example of the pneumatic tire according to the embodiment.

A general cross-sectional structure of the pneumatic tire according to the embodiment is as follows. First, bead sections are provided on both sides in a tire width direction and carcass plies are folded from an inner side to an outer side in the tire width direction to wrap the bead sections and form a skeleton of the pneumatic tire. A plurality of belts are provided on an outer side in a tire radial direction of the carcass plies, and a tread having a ground contact surface on an outer side in the tire radial direction of the belts is provided. Sidewalls are provided on both sides in the tire width direction of the carcass plies. A plurality of members necessary for functions of tires are provided in addition to the above members.

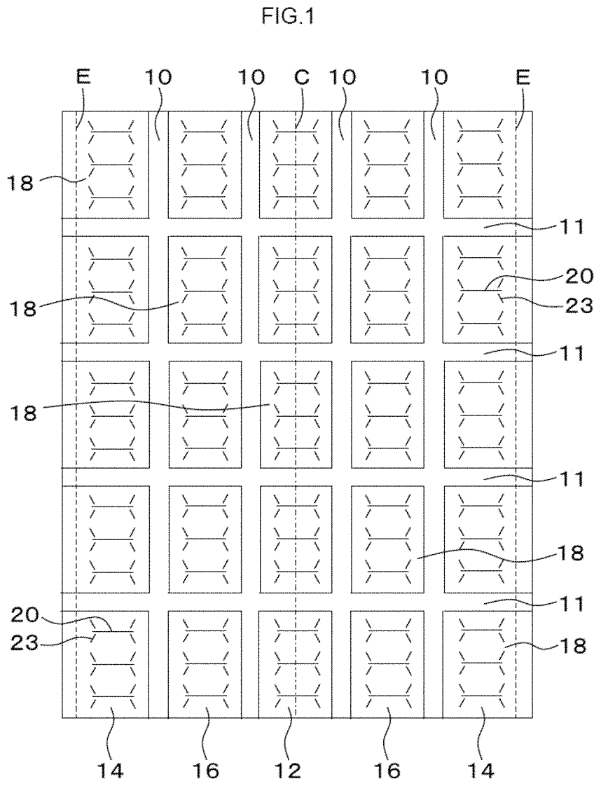

A tread pattern as shown in FIG. 1 is formed on the tread. In the illustrated tread pattern, four main grooves 10 extending in a tire circumference direction are formed. Although a depth of the main grooves 10 is not limited, the depth is, for example, 17 mm or more to 22 mm or less. Then, as regions demarcated by the main grooves 10, a center region 12 through which a center line C in the tire width direction passes, shoulder regions 14 between tire ground contact ends E as both end parts in the tire width direction on the ground contact surface of the tread and the main grooves 10 and mediate regions 16 between the center region 12 and the shoulder regions 14 are formed.

Moreover, in the center region 12, the shoulder regions 14 and the mediate regions 16, blocks 18 as land sections demarcated by a plurality of lateral grooves 11 extending in the wire width direction are respectively arranged side by side in a tire circumferential direction.

However, the tread pattern is just an example. The number of main grooves, the existence of lateral grooves, inclinations of respective grooves with respect to the tire circumferential direction and the tire width direction and the like are not limited to the state shown in FIG. 1. The land sections in respective regions may be ribs extending in the tire circumferential direction without being divided by the lateral grooves, however, the case where the land sections in respective regions are the blocks 18 will be explained below.

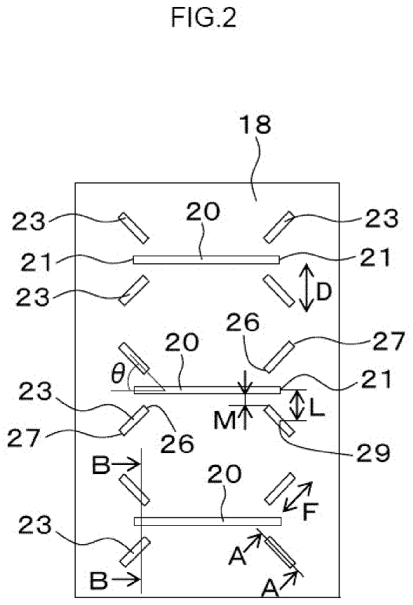

As shown in FIG. 1 and FIG. 2, one or plural main sipes 20 are formed in these blocks 18. The main sipes 20 extend in the tire width direction in plan view in FIG. 1 and FIG. 2, however, the main sipes 20 may also extend so as to be inclined with respect to the tire width direction in plan view and may also extend in the tire circumferential direction.

In the present embodiment, both end parts in an extending direction of the main sipe 20 are blocked ends 21 that are blocked inside the block 18. However, it is also preferable that only one end part in the extending direction of the main sipe 20 is the blocked end 21 and the other end part opens to the main groove 10 or the like from a block end.

The main sipes 20 are drawn to have a straight line shape in plan view in FIG. 2, however, the main sipes 20 may have a wave shape or a zigzag shape. A cross-sectional shape in a depth direction and the extending direction of the main sipes 20 is an approximately rectangular shape though not shown. In a case where plural main sipes 20 are formed in each block 18, these plural main sipes 20 may extend in parallel to one another in plan view as shown in FIG. 2.

Specific numerical values in length, width and depth of the main sipe 20 are not limited. As examples, the width of the main sipe 20 is 0.3 mm or more to 0.8 mm or less, and the depth of the main sipe 20 is 50% or more to 70% or less of the depth of the main groove 10. The depth of the main sipe 20 means a length in the tire radial direction of the main sipe 20.

As shown in FIG. 1 and FIG. 2, auxiliary sipes 23 separated from the main sipe 20 are formed on both sides of the blocked ends 21 of the main sipe 20. The blocked end 21 of the main sipe 20 overlaps with auxiliary sipes 23 on both sides in a direction orthogonal to the extending direction of the main sipe 20 (an arrow D direction in FIG. 2). In auxiliary sipe ends 26, 27 as both end parts in an extending direction of the auxiliary sipe 23, one auxiliary sipe end 26 overlaps with the main sipe 20 in the direction orthogonal to the extending direction of the main sipe 20, and the other auxiliary sipe end 27 does not overlap with the main sipe 20 in the direction orthogonal to the extending direction of the main sipe 20.

The extending direction of the auxiliary sipe 23 is inclined with respect to the extending direction of the main sipe 20 in plan view. The auxiliary sipes 23 obliquely extend in a radial fashion when centering the main sipe 20, and auxiliary sipe ends 26 on one side are close to the main sipe 20 as shown in FIG. 2. An angle made by the extending direction of the auxiliary sipe 23 and the extending direction of the main sipe 20 (an angle θ shown in FIG. 2) is preferably 15° or more to 75° or less, and more preferably 35° or more to 55°.

A distance L between an auxiliary sipe center 29 as a center in the extending direction of the auxiliary sipe 23 and the blocked end 21 of the main sipe 20 is 10% or more to 20% or less of the depth of the main sipe 20. A shortest distance M between the auxiliary sipe end 26 and the main sipe 20 is preferably 5% or more to 15% or less of the depth of the main sipe 20.

The auxiliary sipe 23 preferably has a straight line shape in plan view, however, the auxiliary sipe 23 may also extend in one direction as a whole while having a bent part or a curved part. It is also preferable that the auxiliary sipe 23 is shorter than the main sipe 20.

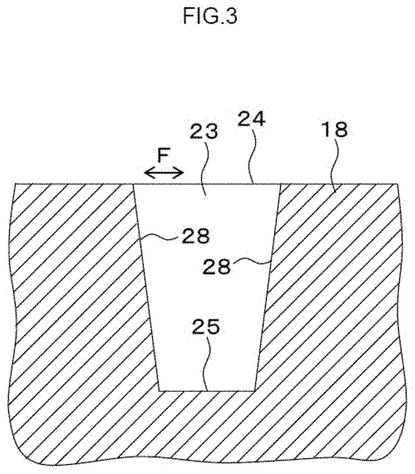

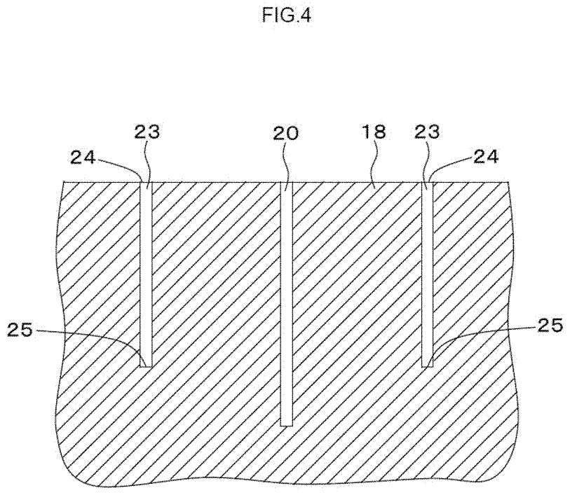

As shown in FIG. 3, the auxiliary sipe 23 gradually becomes short as coming toward the depth direction. That is, the length in the extending direction (an arrow F direction in FIG. 2 and FIG. 3) of the auxiliary sipe 23 becomes shorter as coming toward a deeper position. Moreover, the auxiliary sipe 23 is deepened toward the tire radial direction as shown in FIG. 4 in the embodiment.

As shown in FIG. 3, an opening end 24 with respect to a ground contact surface side and a bottom surface 25 of the auxiliary sipe 23 are parallel to each other in the embodiment. Moreover, wall parts 28 on both sides in the extending direction of the auxiliary sipe 23 continue from the opening end 24 to the bottom part 25 to draw straight lines in a cross section in a depth direction and in the extending direction of the auxiliary sipe 23. Therefore, the auxiliary sipe 23 has a trapezoidal shape in the cross section in the depth direction and in the extending direction thereof as shown in FIG. 3. It is not always necessary that the bottom part 25 of the auxiliary sipe 23 is parallel to the opening end 24 but it is preferable that the bottom part 25 is not pointed.

Specific numerical values in length, width and depth of the auxiliary sipe 23 are not limited. The width of the auxiliary sipe 23 may be the same as the width of the main sipe 20 but may be narrower than the width of the main sipe 20 as well as may be wider than the width of the main sipe 20. The depth of the auxiliary sipe 23 is preferably ⅓ or more and equal to or less than the depth of the main sipe 20. The depth of the auxiliary sipe means a length from the opening end 24 to the bottom part 25 in the tire radial direction. The bottom part 25 of the auxiliary sipe 23 indicates the deepest part of the auxiliary sipe 23 in this case. The auxiliary sipe 23 is the deepest at, for example, the auxiliary sipe center 29.

The length, the width and the depth of all auxiliary sipes 23 formed with respect to one main sipe 20 are the same in the embodiment. However, at least any one of the length, the width and the depth of the auxiliary sipe 23 may differ in respective auxiliary sipes 23.

In the embodiment, two auxiliary sipes 23 are respectively formed with respect to the blocked ends 21 on both sides in the extending direction of the main sipe 20. However, it is also preferable that two auxiliary sipes 23 are formed only with respect to one blocked end 21 in the case where both end parts in the extending direction of the main sipe 20 are the blocked ends 21.

Furthermore, it is not always necessary that another sipe does not exist at positions farther than the auxiliary sipes 23 on both sides in the extending direction of the main sipe 20 as shown in FIG. 1 and FIG. 2.

In the present invention, the main sipe 20 and the auxiliary sipe 23 indicate grooves with a narrow width. More precisely, the sipes are the grooves in which an opening to the ground contact surface is closed under a condition that the pneumatic tire fitted to a normal rim and filled with a normal internal pressure is made to contact on the ground and a normal load is added thereto.

Here, the normal rim is a “standard rim” in JATMA standard, “Design Rim” in TRA standard or “Measuring Rim” in ETRTO standard. The normal internal pressure is “the maximum air pressure” in JATMA standard, the maximum value of “TIRE LOAD LIMITS AT VARIOUS COLD INFLATION PRESSURES” in TRA standard, or “INFLATION PRESSURE” in ETRTO standard. The normal load is “the maximum load ability” in JATMA standard, the maximum value of “TIRE LOAD LIMITS AT VARIOUS COLD INFLATION PRESSURES” in TRA standard or “LOAD CAPACITY” in ETRTO standard.

As described above, the auxiliary sipes 23 are formed on both sides of the blocked ends 21 of the main sipe 20 in the embodiment, therefore, stress is not concentrated on the blocked ends 21 of the main sipe 20 when the block 18 is deformed and cracks hardly occur. Here, the blocked end 21 of the main sipe 20 overlaps with auxiliary sipes 23 on both sides in the direction orthogonal to the extending direction of the main sipe 20, therefore, concentration of stress on the blocked end 21 of the main sipe 20 can be avoided as the auxiliary sipes 23 are closed when stress is applied in the direction orthogonal to the extending direction of the main sipe 20. As the extending direction of the auxiliary sipes 23 is inclined to the extending direction of the main sipe 20, therefore, the auxiliary sipes 23 are closed when stress is applied in the direction of the main sipe 20 and concentration of stress on the blocked end 21 of the main sipe 20 can be avoided. As the concentration of stress on the blocked ends 21 of the main sipe 20 can be avoided as described above, cracks starting from the blocked ends 21 of the main sipe 20 hardly occur.

As the above auxiliary sipes 23 are separated from the main sipe 20, rigidity of the block 18 is not reduced too much as compared with a case where the auxiliary sipes are connected to the main sipe. Furthermore, the auxiliary sipe 23 gradually becomes short as coming toward the depth direction, therefore, rigidity of the block 18 is not reduced too much as compared with a case where the length of the auxiliary sipe 23 is constant in the depth direction (namely, a cross-sectional shape in the depth direction and the extending direction of the auxiliary sipe is a rectangular shape).

Incidentally, the auxiliary sipes 23 gradually become short as coming toward the depth direction, therefore, the auxiliary sipes 23 become shorter as wear of the block 18 proceeds. Accordingly, the effect of avoiding concentration of stress by the auxiliary sipes 23 seems to be reduced as wear of the block 18 proceeds. However, a deformation amount of the block 18 is reduced as the block 18 is worn down and reduced in height, therefore, stress applied to the blocked ends 21 of the main sipe 20 is reduced. Consequently, even when the block 18 is worn down and the auxiliary sipes 23 are shortened, concentration of stress applied to the blocked ends 21 of the main sipe 20 can be sufficiently avoided.

The auxiliary sipe center 29 is a central position where the effect of avoiding the concentration of stress on the blocked ends 21 of the main sipe 20 is exerted, which is also a central position where a cause of reducing rigidity of the block 18 is generated. Accordingly, the auxiliary sipe center 29 is preferably close to the blocked end 21 for allowing the effect of avoiding concentration of stress on the blocked end 21 to be sufficiently exerted, and the auxiliary sipe center 29 is preferably far from the blocked end 21 for sufficiently securing rigidity of the block 18. Specifically, when the distance L between the auxiliary sipe center 29 and the blocked end 21 is 20% or less of the depth of the main sipe 20, the effect of avoiding concentration of stress on the blocked end 21 is sufficiently exerted. Moreover, when the distance L between the auxiliary sipe center 29 and the blocked end 21 is 10% or more of the depth of the main sipe 20, rigidity of the block 18 is sufficiently secured.

Here, the reason why the upper limit of the distance L between the auxiliary sipe center 29 and the blocked end 21 is increased in proportion to the depth of the main sipe 20 is that rubber moves in a wider range around the main sipe 20 as the depth of the main sipe 20 is becomes deeper. As the main sipe 20 becomes deeper, rubber moves in a wider range around the main sipe 20, therefore, the effect of avoiding concentration of stress on the blocked end 21 can be obtained even when the auxiliary sipe center 29 is far from the blocked end 21 in proportion to the depth of the main sipe 20.

The reason why the lower limit of the distance L between the auxiliary sipe center 29 and the blocked end 21 is reduced in proportion to the depth of the main sipe 20 is that concentration of stress between the blocked end 21 and the auxiliary sipe 23 is increased as the depth of the main sipe 20 becomes deeper. Accordingly, it is preferable that the auxiliary sipe center 29 is kept away from the blocked end 21 in proportion to the depth of the main sipe 20.

Furthermore, when the shortest distance M between the auxiliary sipe end 26 and the main sipe 20 is 5% or more to 15% or less of the depth of the main sipe 20 in the case where the distance L between the auxiliary sipe center 29 and the blocked end 21 is 10% or more to 20% or less of the depth of the main sipe 20, concentration of stress on the block end 21 can be avoided while suppressing concentration of stress between the auxiliary sipe end 26 and the main sipe 20.

Also, when the depth of the auxiliary sipes 23 is ⅓ or more of the depth of the main sipe 20 as well as equal to or less than the depth of the sipe 20, stress can be sufficiently dispersed by the auxiliary sipes 23.

When the bottom parts 25 of the auxiliary sipes 23 are not pointed, any trouble hardly occurs in a metal mold for molding a pneumatic tire. Specifically, it is necessary to make plate-shaped sipe blades for forming sipes protrude from an inner surface of the metal mold toward the center of the metal mold for forming the sipes in the tread. Here, it is necessary to form tip ends of the protruding sipe blades in a pointed shape for forming the bottom parts of the sipes in the pointed shape. However, the pointed tip ends of the sipe blades are low in strength, therefore, the tip ends of the sipe blades are distorted when pneumatic tires are molded by the metal mold having such sipe blades many times. On the other hand, when the bottom parts 25 of the auxiliary sipes 23 are not pointed, it is not necessary to form the tip ends of the sipe blades in the metal mold in the pointed shape, therefore, the trouble that the tip ends of the sipe blades are distorted hardly occurs.

Next, modification examples of the above embodiment will be explained. Note that various modifications may occur in addition to the following modification examples, and the scope of the invention is not limited to the scope of the above embodiment and the following modification examples.

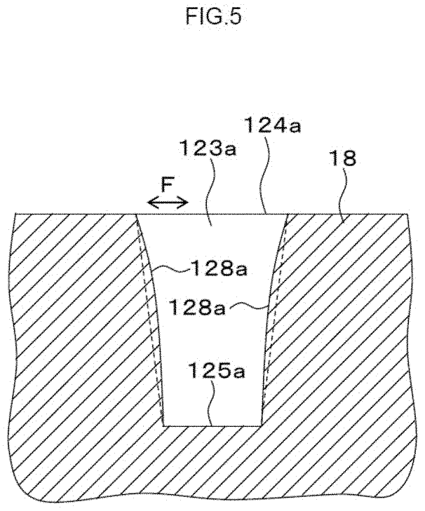

The cross-sectional shape in the depth direction and the extending direction of the auxiliary sipe is not limited to the shape of FIG. 3, and for example, a shape shown in FIG. 5 may be adopted. In an auxiliary sipe 123a shown in FIG. 5, wall parts 128a on both sides in the extending direction thereof are warped toward an inner side of the auxiliary sipe 123a (namely, in a direction of reducing a capacity of the auxiliary sipe 123a) from an opening end 124a to a bottom part 125a of the auxiliary sipe 123a. In other words, the wall parts 128a are curved surfaces that are convex to the inner side of the auxiliary sipe 123a (curved lines on FIG. 5 as a cross-sectional view). The capacity of the auxiliary sipe 123a is reduced as the wall parts 128a is warped, therefore, rigidity of the block 18 is not reduced too much. Broken lines in FIG. 5 indicate the wall parts 28 of the auxiliary sipe 23 of the above embodiment.

The auxiliary sipe may be deepened so as to be inclined with respect to the tire radial direction. For example, an auxiliary sipe 123b is inclined in a direction in which the auxiliary sipe 123b is far from the main sipe 20 at the opening end 124b and is close to the main sipe 20 at the bottom part 125b.

As the auxiliary sipes 123b are shortened as wear of the block 18 proceeds, the effect of avoiding concentration of stress by the auxiliary sipes 23 seems to be reduced as wear of the block 18 proceeds as described above. However, the auxiliary sipe 123b is inclined to the direction coming close to the main sipe 20 as coming close to the bottom part 125b, therefore, the opening end comes close to the main sipe 20 as wear of the block 18 proceeds. Accordingly, even when the block 18 is worn down and the auxiliary sipes 123b are shortened, concentration of stress on the blocked end 21 of the main sipe 20 can be sufficiently avoided by the auxiliary sipes 123b.

In the case where the auxiliary sipe is inclined with respect to the tire radial direction, the depth of the auxiliary sipe does not mean a length of the auxiliary sipe in an inclined direction but a length in the tire radial direction.

At least any one of the main sipe and the auxiliary sipe may be a so-called three-dimensional sipe in which the shape is changed along the depth direction. Specific shapes of the three-dimensional sipe are not limited, and for example, well-known various shapes may be adopted.

The shape of the auxiliary sipes in plan view and the cross-sectional shape of the auxiliary sipes in the depth direction are preferably the same on both sides in the extending direction of the main sipe 20. However, at least one of the shape of the auxiliary sipes in plan view and the cross-sectional shape of the auxiliary sipes in the depth direction may differ on both sides in the extending direction of the sipe 20.

### DESCRIPTION OF REFERENCE NUMERALS AND SIGNS

C . . . center line in tire width direction, E . . . tire ground contact end, 10 . . . main groove, 11 . . . lateral groove, 12 . . . center region, 14 . . . shoulder region, 16 . . . mediate region, 18 . . . block, 20 . . . main sipe, 21 . . . blocked end, 23 . . . auxiliary sipe, 24 . . . opening end, 25 . . . bottom part, 26, 27 . . . auxiliary sipe end, 28 . . . wall part, 29 . . . auxiliary sipe center, 123a, 123b . . . auxiliary sipe, 124a, 124b . . . opening end, 125a, 125b . . . bottom part, 128a . . . wall part

1. A pneumatic tire in which main sipes are formed on land sections of a tread and at least one of ends in an extending direction of each main sipe is a blocked end that is blocked in the land section,
wherein auxiliary sipes separated from the main sipe are formed on both sides of the blocked end,
the blocked end overlaps with the auxiliary sipes on both sides thereof in a direction orthogonal to the extending direction of the main sipe,
a distance between a center in an extending direction of the auxiliary sipe and the blocked end is 10% or more to 20% or less of a depth of the main sipe,
the extending direction of the auxiliary sipes is inclined with respect to the extending direction of the main sipe, and
the auxiliary sipes are gradually shortened as coming toward a depth direction.

2. The pneumatic tire according to claim 1,
wherein a depth of the auxiliary sipe is ⅓ or more of the depth of the main sipe and equal to or less than the depth of the main sipe.

3. The pneumatic tire according to claim 1,
wherein end parts in the extending direction of the auxiliary sipe are warped toward an inner side of the auxiliary sipe from an opening end toward a bottom part of the auxiliary sipe.

4. The pneumatic tire according to claim 1,
wherein the auxiliary sipe is inclined in a direction in which the auxiliary sipe is far from the main sipe at an opening end and is close to the main side at a bottom part.
